(19) United States
(12) Patent Application Publication
(10) Pub. No.: US 2026/0233777 A1
(43) Pub. Date: Aug. 13, 2026

(54) BICYCLE STEERING ASSIST MOTOR UNIT AND BICYCLE INCLUDING BICYCLE STEERING ASSIST MOTOR UNIT

(71) Applicant: YAMAHA HATSUDOKI KABUSHIKI KAISHA, Iwata-shi (JP)

(72) Inventors: Tomoyuki HIGASHI, Shizuoka (JP); Mitsuharu HASUMI, Shizuoka (JP); Nobuo HARA, Shizuoka (JP); Shiro NAKADA, Kyoto-shi (JP)

(21) Appl. No.: 19/639,354

(22) Filed: Apr. 6, 2026

Related U.S. Application Data
(63) Continuation-in-part of application No. PCT/JP2024/035798, filed on Oct. 7, 2024.

(30) Foreign Application Priority Data
Oct. 6, 2023 (WO) PCT/JP2023/036642

(51) Int. Cl. B62D 5/04; B62K 21/12; B62K 21/18

(52) U.S. Cl. CPC B62D 5/0409; B62K 21/12; B62K 21/18

(57) ABSTRACT

A steering assist motor unit includes a torque transmission rotating body in a second torque transmission path that transmits a torque of a steering assist motor to a first torque transmission path. The torque transmission rotating body includes an inner surface through which a steering column extends such that the torque of steering assist motor is not directly transmitted from the torque transmission rotating body to the steering column. The second torque transmission path includes a bicycle stem aligned with the torque transmission rotating body in an axial direction, attached to the steering column to integrally rotate with the steering column, so that a torque is transmitted from the torque transmission rotating body to the steering column. The bicycle stem includes a torque transmitter that contacts a portion of the torque transmission rotating body to transmit a torque between the bicycle stem and the torque transmission rotating body.

### CROSS REFERENCE TO RELATED APPLICATIONS

This application claims the benefit of priority to PCT Application No. PCT/JP2023/036642 filed on Oct. 6, 2023 and is a Continuation-in-Part Application of PCT Application No. PCT/JP2024/035798 filed on Oct. 7, 2024. The entire contents of each application are hereby incorporated herein by reference.

### BACKGROUND OF THE INVENTION

### 1. Field of the Invention

The present invention relates to bicycle steering assist motor units and bicycles including the bicycle steering assist motor units.

### 2. Description of the Related Art

Bicycle steering assist motor units that assist steering of a handle of a bicycle are known. For example, U.S. Patent Application Publication No. 2020/0102043 discloses a robotic steering mechanism for an autonomous bicycle including a sensor, a steering control assembly configured to adjust a steering angle of a front wheel of a bicycle, and a controller that obtains a value from the sensor. The controller adjusts the steering angle by the steering control assembly based on the value obtained by the sensor.

U.S. Patent Application Publication No. 2020/0102043 further discloses a point that the steering control assembly includes a steering actuator, a steering column, and a gear assembly. U.S. Patent Application Publication No. 2020/0102043 also discloses a point that a steering gear of the gear assembly is mounted on the steering column by a set screw. FIG. 4 of U.S. Patent Application Publication No. 2020/0102043 discloses an ahead stem structure as a structure that connects a handlebar to the steering column.

Incidentally, the ahead stem structure disclosed in U.S. Patent Application Publication No. 2020/0102043 includes a top cap, a lifting member, and a bicycle stem. The lifting member is located inward of an upper portion of the steering column and expands to press against an inner surface of the steering column by rotating the top cap. Thus, it is allowed to lift the steering column in an axial direction by the lifting member. The top cap is located at an upper end of the steering column and is connected to the lifting member via a screw portion. The bicycle stem is connected to the outer peripheral surface of the steering column.

In the configuration disclosed in U.S. Patent Application Publication No. 2020/0102043, it is necessary to machine a threaded hole in the steering column through which a screw for attaching the steering gear of the gear assembly extends. After machining the threaded hole in the steering column, when the top cap in the ahead stem structure is caused to rotate, and the steering column is lifted by the lifting member, a position of the threaded hole is changed in the axial direction of the steering column.

Therefore, in the configuration disclosed in U.S. Patent Application Publication No. 2020/0102043, it is difficult to assemble a torque transmission rotating body of a torque transmission, which transmits an output torque of the steering gear (i.e., the motor) to the steering column, onto the steering column using the set screw.

To cope with the difficulty described above, a configuration of a motor unit that allows the torque transmission rotating body that transmits the output torque of the motor to a rotation axis of the steering column or the like to be easily assembled to the steering column is desired.

### SUMMARY OF THE INVENTION

Example embodiments of the present invention provide motor units that each allow a torque transmission rotating body that transmits an output torque of a motor to a steering column or the like to be easily assembled.

Inventors of example embodiments of the present invention studied a configuration in which a torque of a motor is transmitted to a steering column without performing machining on the steering column.

As a result of intensive studies, the inventors conceived of and developed configurations in which a tightening member is mounted on a steering column such that an output torque of a motor is not directly transmitted to the steering column by a torque transmission rotating body that transmits the output torque to the steering column, but instead the output torque is transmitted to the steering column via the torque transmission rotating body and the tightening member. Thus, unlike the configuration disclosed in U.S. Patent Application Publication No. 2020/0102043, without providing a threaded hole to the steering column, the output torque of the motor can be transmitted to the steering column.

Accordingly, the torque transmission rotating body that transmits the output torque of the motor to the steering column or the like can be easily assembled to the steering column.

As a result of the studies described above, the inventors conceived of and developed the following example embodiments of the present invention.

A bicycle steering assist motor unit according to an example embodiment of the present invention includes a torque transmission rotating body mountable on a steering column connected to a handlebar such that the steering column and the handlebar integrally rotate. The torque transmission rotating body is in a second torque transmission path through which a torque of a motor is transmitted to a first torque transmission path through which a torque input to the handlebar is transmitted to the steering column. The torque transmission rotating body protrudes upward from a vehicle body frame to rotate integrally with the handlebar and includes an inner surface through which a steering column extends via a gap such that the torque transmission rotating body is inserted relative to the steering column included in the first torque transmission path and the torque of the motor is not directly transmitted to an outer peripheral surface of the steering column from the torque transmission rotating body. The second torque transmission path includes a tightening member that is separate from the torque transmission rotating body such that the torque of the motor transmitted from the torque transmission rotating body is transmitted to the steering column, is aligned with the torque transmission rotating body in an axial direction of the steering column, and is attached to the outer peripheral surface of the steering column in a tangential direction to at least partially contact the outer peripheral surface of the steering column and integrally rotate with the steering column. The tightening member includes a torque transmitter that contacts a portion of the torque transmission rotating body or a rotation transmission member that integrally rotates with the torque transmission rotating body to transmit a torque between the torque transmitter and the torque transmission rotating body.

In the above-described configuration, the tightening member is aligned with the torque transmission rotating body in the axial direction of the steering column, and is attached to the outer peripheral surface of the steering column in the tangential direction to integrally rotate with the steering column. The torque transmitter of the tightening member contacts a portion of the torque transmission rotating body or the rotation transmission member that integrally rotates with the torque transmission rotating body and thus transmits a torque between the torque transmitter and the torque transmission rotating body. Thus, the tightening member causes the torque transmission rotating body to rotate with the steering column.

The torque transmission rotating body that integrally rotates with the steering column by the tightening member in the above-described manner includes a gap between the inner surface and the steering column. Thus, the second torque transmission path that is a transmission path of a torque from the motor to the steering column can be realized by mounting the torque transmission rotating body on the steering column later without performing precise machining on the torque transmission rotating body and the steering column.

Therefore, the configuration of the motor unit allows the torque transmission rotating body that transmits the output torque of the motor to the steering column or the like to be easily assembled to the steering column.

Furthermore, when the above-described configuration is applied to an ahead stem structure, as the tightening member, a head stem can be used. Thus, the above-described configuration can be realized without increasing the number of parts.

When the above-described configuration is applied to a quill stem structure, the tightening member is attached to a steering column of a quill stem, and therefore, the tightening member can be tightened using a rigidity of the steering column. Therefore, the tightening member can be more firmly attached to and mounted on the steering column, and the torque of the motor can be more reliably transmitted to the steering column.

According to another example embodiment of the present invention, the bicycle steering assist motor unit may include the following configuration. The torque transmitter of the tightening member includes (1) a side surface of the tightening member that, upon receiving a load in the axial direction of the steering column, contacts a near side surface to the torque transmission rotating body or the tightening member in the rotation transmission member and is at or adjacent to the torque transmission rotating body, (2) a first recess of the tightening member that contacts a first projection that protrudes in the axial direction of the steering column from the torque transmission rotating body or the rotation transmission member, or (3) a second projection of the tightening member that contacts a second recess that is recessed in the axial direction of the steering column in the torque transmission rotating body or the rotation transmission member.

Thus, the torque transmitter transmits a torque between the tightening member and the torque transmission rotating body in the tightening member. That is, in (1), upon receiving a load in the axial direction of the steering column, the tightening member contacts the torque transmission rotating body or the rotation transmission member, and thus, the tightening member causes the torque transmission rotating body to integrally rotate with the steering column. Also, in (2), the first recess of the tightening member contacts the first projection that protrudes in the axial direction of the steering column from the torque transmission rotating body or the rotation transmission member, and thus, the tightening member causes the torque transmission rotating body integrally rotate with the steering column. Moreover, in (3), the second projection of the tightening member contacts the second recess that is recessed in the axial direction of the steering column in the torque transmission rotating body or the rotation transmission member, and thus, the tightening member causes the torque transmission rotating body to integrally rotate with the steering column.

Therefore, the configuration of the motor unit allows the torque transmission rotating body that transmits the output torque of the motor to the steering column or the like to be easily assembled to the steering column.

According to another example embodiment of the present invention, the bicycle steering assist motor unit may include the following configuration. The torque transmission rotating body is located lower than the tightening member in the axial direction of the steering column.

Thus, since the torque transmission rotating body and the motor are located lower than the tightening member, the torque transmission rotating body and the motor are located even lower than the steering column and, interruption of the torque transmission rotating body and the motor to a handle operation can be prevented.

According to another example embodiment of the present invention, the bicycle steering assist motor unit may include the following configuration. The torque transmission rotating body and the tightening member, or the torque transmission rotating body, the rotation transmission member, and the tightening member are pressed toward each other in the axial direction of the steering column by an axial direction pressing mechanism.

Thus, the torque transmission rotating body and the tightening member, or the torque transmission rotating body, the rotation transmission member, and the tightening member are pressed toward each other in the axial direction of the steering column. Accordingly, the tightening member causes the torque transmission rotating body to integrally rotate with the steering column.

Therefore, the configuration of the motor unit allows the torque transmission rotating body that transmits the output torque of the motor to the steering column or the like to be easily assembled to the steering column.

Moreover, in a case of an ahead stem, the axial direction pressing mechanism can be a portion of the ahead stem. Therefore, the above-described configuration can be realized without adding a new part or the like.

According to another example embodiment of the present invention, the bicycle steering assist motor unit may include the following configuration. The torque transmission rotating body and the tightening member are pressed downward in the axial direction of the steering column by the axial direction pressing mechanism.

Thus, the torque transmission rotating body and the tightening member can be pressed toward the vehicle body frame or the like, and therefore, the torque transmission rotating body can be sandwiched between the tightening member and the vehicle body frame. Accordingly, the tightening member causes the torque transmission rotating body to integrally rotate with the steering column.

Therefore, the configuration of the motor unit allows the torque transmission rotating body that transmits the output torque of the motor to the steering column or the like to be easily assembled to the steering column.

According to another example embodiment of the present invention, the bicycle steering assist motor unit may include the following configuration. The rotation transmission member is located between the torque transmission rotating body and the tightening member.

Thus, the rotation transmission member causes the torque transmission rotating body and the tightening member to integrally rotate. Accordingly, the torque transmission rotating body integrally rotates with the steering column by the tightening member.

Therefore, the configuration of the motor unit allows the torque transmission rotating body that transmits the output torque of the motor to the steering column or the like to be easily assembled to the steering column.

According to another example embodiment of the present invention, the bicycle steering assist motor unit may include the following configuration. The rotation transmission member includes a recess that fits with a torque transmission projection on the torque transmission rotating body or a projection that fits with a torque transmission recess on the torque transmission rotating body, or includes a rotation transmission member torque transmitter that contacts, upon receiving a load in the axial direction of the steering column, a side surface of the torque transmission rotating body.

Thus, the rotation transmission member and the torque transmission rotating body can integrally rotate. Since the rotation transmission member contacts the tightening member to integrally rotate therewith, the torque transmission rotating body integrally rotates with the tightening member via the rotation transmission member. Accordingly, the tightening member causes the torque transmission rotating body to integrally rotate with the steering column.

Therefore, the configuration of the motor unit allows the torque transmission rotating body that transmits the output torque of the motor to the steering column or the like to be easily assembled to the steering column.

According to another example embodiment of the present invention, the bicycle steering assist motor unit may include the following configuration. The torque transmission rotating body directly contacts the tightening member, and not via the rotation transmission member.

Thus, even without the rotation transmission member, the tightening member causes the torque transmission rotating body can integrally rotate with the steering column.

Therefore, the configuration of the motor unit allows the torque transmission rotating body that transmits the output torque of the motor to the steering column or the like to be easily assembled to the steering column.

A bicycle according to an example embodiment of the present invention includes the bicycle steering assist motor unit having the above-described configuration. In the bicycle, the torque transmission rotating body that transmits the output torque of the motor to the steering column can be easily assembled to the steering column.

The terminology used herein is for the purpose of describing particular example embodiments only and is not intended to limit the present invention.

As used herein, the term “and/or” includes any and all combinations of one or more of the associated listed items.

It will be further understood that the terms “including,” “comprising” or “having” and variations thereof when used in this specification, specify the presence of stated features, steps, operations, elements, components, and/or their equivalents, but do not preclude the presence or addition of one or more steps, operations, elements, components, and/or groups thereof.

It will be further understood that the terms “mounted,” “connected,” “coupled,” and/or their equivalents thereof are used broadly and encompass both “direct and indirect” mounting, connecting, and coupling. Furthermore, “connected” and “coupled” are not restricted to physical or mechanical connections or couplings, and can include electrical connections or couplings whether direct or indirect.

Unless otherwise defined, all terms (including technical and scientific terms) used herein have the same meaning as commonly understood by one having ordinary skill in the art to which the present invention belongs.

It will be further understood that terms, such as those defined in commonly used dictionaries, should be interpreted as having a meaning that is consistent with their meaning in the context of the relevant art and example embodiments of the present invention and will not be interpreted in an idealized or overly formal sense unless expressly so defined herein.

In describing example embodiments of the present invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the present invention.

In this specification, example embodiments of bicycle steering assist motor units according to the present invention will be described.

In the following description, for purposes of explanation, numerous specific details are set forth in order to provide a thorough understanding of the present invention. It will be evident, however, to one skilled in the art that the present invention can be practiced without these specific details.

Therefore, the following disclosure is to be considered as an exemplification of the present invention, and is not intended to limit the present invention to the specific example embodiments illustrated by the figures or description below.

In this specification, the term “bicycle” refers to a vehicle that includes a handlebar, a steering column that extends through a head tube, at least one front wheel, and at least one rear wheel and that obtains a driving force by a rider rotating pedals. The bicycle may be a two-wheeled vehicle, or may be a three-wheeled vehicle. The bicycle may be a vehicle that leans leftward or rightward, or may be a vehicle that does not lean leftward or rightward.

In this specification, the term “vehicle body frame” refers to a frame of the bicycle, and includes members, such as a head tube, a top tube, a down tube, or the like, that constitute a skeleton of a bicycle.

In this specification, the term “handlebar” refers to a bar handle that extends in the left-right direction. A handlebar connector of a bicycle stem is connected to a central portion of the handlebar in the left-right direction.

In this specification, the term “assist” refers to an operation of auxiliary inputting a rotational driving force to a steering column to which the handlebar is connected, the rotational driving force rotating the handlebar around an axis of the steering column by an actuator based on an input of a force of a rider to the handlebar or an input of an external force that is transmitted to the steering column via a front wheel. The assist includes the operation occurring in a case where the rotational driving force is input to the steering column so as to increase the input of the force of the rider to the handlebar and the operation occurring in a case where the rotational driving force is input to the steering column so as to reduce the input of the external force that is transmitted to the steering column. When the input of the force of the rider to the handlebar is increased, the rotational driving force is input to the steering column in a direction in which the steering column is caused to further rotate. On the other hand, when the input of the external force that is transmitted to the steering column is reduced, the rotational driving force is input to the steering column in a direction in which rotation of the steering column is suppressed.

In this specification, the term “rotation axis” refers to a steering column that is connected to a front fork that is rotatably housed in a head tube and rotatably supports a front wheel or an axial-shaped part that is connected to the steering column. A steering force is transmitted to the steering column from a handlebar and, on the other hand, an external force is transmitted to the steering column via the front fork.

In this specification, the term “first torque transmission path” refers to a path through which a torque input to a handlebar is transmitted to a steering column from the handlebar. The first torque transmission path includes a path through which a torque is transmitted to the handlebar from the steering column. The first torque transmission path includes a part, such as a handlebar, a stem, a steering column gear, or the like, that performs transmission of the torque from the handlebar to the steering column.

In this specification, the term “second torque transmission path” refers to a path through which a torque output from a motor is transmitted to the first torque transmission path. The second torque transmission path includes a path through which a torque is transmitted to the motor from the first torque transmission path. The second torque transmission path includes members that can transmit a torque, such as a gear, a pulley, a link, a belt, a chain, a sprocket, or the like, and also includes a motor, or the like.

In this specification, the term “near side surface to a certain member” refers to a closest side surface to the certain member among side surfaces of a target member. For example, when a tightening portion arranged in an axial direction of a rotation axis relative to a torque transmission rotating body has a cylindrical shape, each of both end surfaces of the tightening member in an axial direction is a side surface and, of the both end surfaces, one end surface located at or adjacent to the torque transmission rotating body is a near side surface to the torque transmission rotating body. Note that, even when the target member has some other shape than a cylindrical shape, among surfaces of the target member, a nearest portion to the certain member is a near side surface to the certain member.

In this specification, the term “integrally rotate” includes not only a case where separate members are directly connected to each other and rotate integrally but also a case where separate members are indirectly connected via another member and thus rotate integrally.

In this specification, the term “tighten” refers to a state where a member is tightened to an outer peripheral surface of a steering column by a tightening member to fix the member to the steering column. At least a portion of the tightened member is pressed against the outer peripheral surface of the steering column to be in contact therewith.

According to example embodiments of the present invention, the configurations of motor units each allow a torque transmission rotating body that transmits an output torque of a motor to a steering column to be easily assembled to the steering column.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a left side view illustrating an outline configuration of a bicycle steering assist motor unit according to a first example embodiment of the present invention.

FIG. 2 is a left side view illustrating an outline configuration of a bicycle steering assist motor unit according to a second example embodiment of the present invention.

FIG. 3 is a left side view illustrating an outline configuration of a bicycle including a bicycle steering assist motor unit according to a third example embodiment of the present invention.

FIG. 4 is a view illustrating an outline configuration of a bicycle stem and a steering assist device.

FIG. 5 is a left side view illustrating an example of a bicycle stem according to a fourth example embodiment of the present invention.

FIG. 6 is a view illustrating the bicycle stem and the bicycle steering assist motor unit as viewed from above.

FIG. 7 is a left side view illustrating an outline configuration of a bicycle in which a steering assist motor and a battery are housed in a down tube.

### DETAILED DESCRIPTION OF THE EXAMPLE EMBODIMENTS

Example embodiments of the present invention will be described hereinafter with reference to the drawings. In the drawings, the same or corresponding components are denoted by the same reference characters, and description thereof will not be repeated. The dimensions of components in the drawings do not strictly represent actual dimensions of the components and dimensional proportions of the components, for example.

In the following description, an arrow F in the drawings represents a forward direction of a vehicle. An arrow RR in the drawings represents a rearward direction of the vehicle. An arrow U in the drawings represents an upward direction of the vehicle. An arrow D in the drawings represents a downward direction of the vehicle. An arrow L in the drawings represents a leftward direction of the vehicle. An arrow R in the drawings represents a rightward direction of the vehicle. In the following description, an up-down direction, a left-right direction, and a front-rear direction refer to an up-down direction, a left-right direction, and a front-rear direction, respectively, as viewed from a rider riding a bicycle.

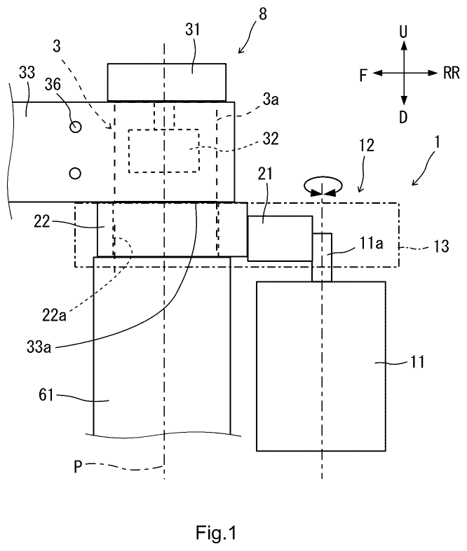

With reference to FIG. 1, a bicycle steering assist motor unit 1 according to a first example embodiment of the present invention will be described. FIG. 1 is a left side view illustrating an outline configuration of the bicycle steering assist motor unit 1 according to the first example embodiment.

The bicycle steering assist motor unit 1 includes a steering assist motor 11 (motor) and a torque transmission 12.

The steering assist motor 11 outputs a torque that rotates a steering column 3 (rotation axis). The steering assist motor 11 is connected to the torque transmission 12 so as to transmit an output torque thereto. That is, an output shaft 11a of the steering assist motor 11 is connected to the torque transmission 12 so as to input the output torque thereto.

Note that, although not specifically illustrated, the steering assist motor 11 is supported by a vehicle body frame of a bicycle. In an example illustrated in FIG. 1, the steering assist motor 11 is located in front of the steering column 3, but may be located behind, at the left of, or at the right of the steering column 3, or the like, as long as the steering assist motor 11 is located at or adjacent to the steering column 3.

The torque transmission 12 transmits the output torque of the steering assist motor 11 to the steering column 3. Specifically, the torque transmission 12 includes a torque transmitter 21 and a torque transmission rotating body 22.

The torque transmission rotating body 22 is located on an outer peripheral surface 3a of the steering column 3. The torque transmission rotating body 22 includes an inner surface 22a through which the steering column 3 extends via a gap, such that the torque transmission rotating body 22 is easily inserted around the steering column 3 and the torque from the motor 3 is not directly transmitted from the torque transmission rotating body 22 to the outer peripheral surface of the steering column 3. That is, in a state where the steering column 3 extends through the torque transmission rotating body 22, a gap is formed between the steering column 3 and the inner surface 22a of the torque transmission rotating body 22. The torque transmission rotating body 22 includes a through hole with an inner diameter larger than an outer diameter of the steering column 3. An inner surface of the through hole corresponds to the inner surface 22a.

The torque transmission rotating body 22 is located above a head tube 61. Although not specifically illustrated, a bearing is provided between the torque transmission rotating body 22 and the head tube 61 to support the torque transmission rotating body 22 so that the torque transmission rotating body 22 is rotatable relative to the head tube 61 about an axis P of the steering column 3.

The torque transmitter 21 is connected to the output shaft 11a of the steering assist motor 11 so as to transmit a torque and is also connected to the torque transmission rotating body 22 so as to transmit a torque. Thus, the torque transmitter 21 transmits a torque output from the output shaft 11a of the steering assist motor 11 to the torque transmission rotating body 22. As will be described below, the torque transmission rotating body 22 transmits the torque of the steering assist motor 11 through a first torque transmission path through which the torque input to a handlebar is transmitted to the steering column 3. The torque transmission rotating body 22 defines a portion of a second torque transmission path.

Each of the torque transmitter 21 and the torque transmission rotating body 22 may be a portion of a mechanism, such as a gear, a pulley, a link, a belt, a chain, a sprocket, or the like, that can transmit a torque. Each of the torque transmitter 21 and the torque transmission rotating body 22 may be configured to change (amplify or reduce) the torque output from the steering assist motor 11.

The torque transmission 12 is housed in a casing 13. The casing 13 is supported by the vehicle body frame of the bicycle. Therefore, the torque transmission 12 can rotate relatively to the casing 13. The output shaft 11a of the steering assist motor 11 may be located inside the casing 13 and may be located outside the casing 13.

The steering column 3 is held up relative to the vehicle body frame of the bicycle (head tube 61) by a top cap 31 and an anchor 32 in a state where the steering column 3 extends through the head tube 61 of the bicycle. Accordingly, the steering column 3 protrudes upward relative to the vehicle body frame.

Specifically, the anchor 32 is located inside an upper portion of the steering column 3. A screw portion of the top cap 31 is rotatably connected to an upper portion of the anchor 32. The anchor 32 is configured such that an outer surface thereof moves radially by using a tool dedicated to mounting an anchor. The anchor 32 is fixed onto an inner peripheral surface of the steering column 3 in a state where the outer surface radially moves to press the inner peripheral surface of the steering column 3. The top cap 31 is arranged in a state where a bicycle stem 33 and a portion of the bicycle steering assist motor unit 1 (the torque transmission rotating body 22) each of which is connected to the steering column 3 are sandwiched between the top cap 31 and an end surface of the head tube 61 in an axial direction. Specifically, although not illustrated, a bearing is provided between the torque transmission rotating body 22 and the head tube 61.

Note that, in this example embodiment, the torque transmission rotating body 22 of the bicycle steering assist motor unit 1 is located closer to the head tube 61 than the bicycle stem 33 in the axial direction of the steering column 3.

In the configuration described above, by rotating the top cap 31 in the manner described above, the steering column 3 can be held relative to the vehicle body frame of the bicycle (the head tube 61) in the axial direction by the anchor 32. The top cap 31 and the anchor 32 correspond to a lifting member.

As described above, a stem structure of this example embodiment is a so-called ahead stem structure.

The bicycle stem 33 is a separate body from the torque transmission rotating body 22. That is, the bicycle stem 33 and the torque transmission rotating body 22 are separate members. The bicycle stem 33 is fixed to the steering column 3 so as to be rotatable integrally with the steering column 3. Specifically, the bicycle stem 33 is fixed onto the outer peripheral surface of the steering column 3 by being attached to the outer peripheral surface of the steering column 3 in a tangential direction. Thus, at least a portion of the bicycle stem 33 contacts the outer peripheral surface of the steering column 3 and rotates integrally with the steering column 3. Accordingly, the steering column 3 rotates integrally with the bicycle stem 33 connected to the handlebar. A path through which the torque input to the handlebar is transmitted to the steering column 3 via the bicycle stem 33 is the first torque transmission path. The bicycle stem 33 corresponds to a tightening member.

Examples of methods for fixing the bicycle stem 33 to the steering column 3 include clamping, multiple separate parts are located with the steering column 3 radially sandwiched therebetween and are connected by a fastener, or the like. In this example embodiment, the bicycle stem 33 is fixed to the steering column 3 by a fastener 36.

The bicycle stem 33 is aligned with the torque transmission rotating body 22 of the torque transmission 12 in the axial direction of the steering column 3. The torque transmission rotating body 22 is located lower than the bicycle stem 33 in the axial direction of the steering column 3.

Therefore, the steering column 3 is held upward in the axial direction by the top cap 31 and the anchor 32 as described above, and thus, the bicycle stem 33 and the torque transmission rotating body 22 are sandwiched between the top cap 31 and the head tube 61 in the axial direction of the steering column 3. That is, the top cap 31 and the anchor 32 are included in an axial direction pressing mechanism 8 that presses the bicycle stem 33 and the torque transmission rotating body 22 in the axial direction of the steering column 3.

In this example embodiment, the bicycle stem 33 and the torque transmission rotating body 22 are pressed downward in the axial direction of the steering column 3 by the axial direction pressing mechanism 8.

Since the torque transmission rotating body 22 is located between the bicycle stem 33 and the head tube 61, the torque transmission rotating body 22 is pressed in the axial direction with the bicycle stem 33 as described above, so that the torque transmission rotating body 22 rotates integrally with the bicycle stem 33. Accordingly, the torque transmission rotating body 22 rotates integrally with the steering column 3 via the bicycle stem 33.

Thus, when a torque is input from the motor to the torque transmission rotating body 22, the steering column 3 is caused to rotate about the axis P by the torque transmission rotating body 22.

In this example embodiment, the bicycle stem 33 corresponds to a tightening member in the bicycle steering assist motor unit 1. That is, the bicycle steering assist motor unit 1 also uses the bicycle stem 33 to rotate the torque transmission rotating body 22 integrally with the steering column 3.

The bicycle stem 33 includes a torque transmitter 33a that contacts a portion of the torque transmission rotating body 22 to transmit a torque between the bicycle stem 33 and the torque transmission rotating body 22. In this example embodiment, the torque transmitter 33a includes an end surface at or adjacent to the torque transmission rotating body 22 among end surfaces of the bicycle stem 33 in the axial direction. That is, the torque transmitter 33a includes a near side surface of the bicycle stem 33 to the torque transmission rotating body 22, and the torque transmitter 33a receives a load in the axial direction of the steering column 33 and contacts a near side surface of the torque transmission rotating body 22 to the bicycle stem 33.

In this example embodiment, the torque transmission rotating body 22 directly contacts the bicycle stem 33, and not via a rotation transmission member.

The bicycle steering assist motor unit 1 according to this example embodiment includes, on the steering column 3 that is connected to the handlebar via the bicycle stem 33 so as to integrally rotate with the handlebar, the torque transmission rotating body 22 included in the second torque transmission path through which the torque of the steering assist motor 11 is transmitted to the first torque transmission path through which the torque input to the handlebar is transmitted to the steering column 3. The torque transmission rotating body 22 includes the inner surface 22a through which the steering column 3 extends via the gap so as to cause the torque transmission rotating body 22 to protrude upward from the vehicle body frame to integrally rotate with the handlebar and to be easily inserted in the steering column 3 included in the first transmission path and so as not to cause the torque of the steering assist motor 11 to be directly transmitted from the torque transmission rotating body 22 to the outer peripheral surface of the steering column 3. The second torque transmission path includes the bicycle stem 33 that is a separate body from the torque transmission rotating body 22, is aligned with the torque transmission rotating body 22 in the axial direction of the steering column 3, and is attached to the outer peripheral surface of the steering column 3 in the tangential direction to at least partially contact the outer peripheral surface of the steering column 3 and integrally rotate with the steering column 3, so that the torque of the steering assist motor 11 is transmitted from the torque transmission rotating body 22 to the steering column 3. The bicycle stem 33 includes the torque transmitter 33a that contacts a portion of the torque transmission rotating body 22 to transmit a torque between the bicycle stem 33 and the torque transmission rotating body 22.

In the above-described configuration, the bicycle stem 33 is aligned with the torque transmission rotating body 22 in the axial direction of the steering column 3 and is attached to the outer peripheral surface of the steering column 3 in the tangential direction to integrally rotate with the steering column 3. The torque transmitter 33a of the bicycle stem 33 contacts a portion of the torque transmission rotating body 22 to transmit a torque between the bicycle stem 33 and the torque transmission rotating body 22. Thus, the torque transmission rotating body 22 integrally rotates with the steering column 3 by the bicycle stem 33.

The torque transmission rotating body 22 that is caused to integrally rotate with the steering column 3 by the bicycle stem 33 in the above-described manner has a gap between the inner surface thereof and the steering column 3. Thus, the second torque transmission path from the steering assist motor 11 to the steering column 3 can be realized by mounting the torque transmission rotating body 22 on the steering column 3 later without performing precise machining on the torque transmission rotating body 22 and the steering column 3.

Accordingly, a configuration of the bicycle steering assist motor unit 1 that allows the torque transmission rotating body 22 that transmits the output torque of the steering assist motor 11 to the steering column 3 to be easily assembled to the steering column 3 can be realized.

Furthermore, when the above-described configuration is applied to an ahead stem, as the bicycle stem 33, the ahead stem can be used. Thus, the above-described configuration can be realized without increasing the number of parts.

In this example embodiment, the torque transmitter 33a of the bicycle stem 33 is a near side surface of the bicycle stem 33 to the torque transmission rotating body 22, the torque transmitter 33a receives a load in the axial direction of the steering column 3 and contacts a near side surface of the torque transmission rotating body 22 adjacent to the bicycle stem 33. Thus, the torque transmitter 33a that transmits a torque between the bicycle stem 33 and the torque transmission rotating body 22 can be realized in the bicycle stem 33. That is, the torque transmitter 33a of the bicycle stem 33 receives a load in the axial direction of the steering column 3 to contact the torque transmission rotating body 22, and therefore, the torque transmission rotating body 22 can be caused to integrally rotate with the steering column 3 by the bicycle stem 33.

In this example embodiment, the torque transmission rotating body 22 is located lower than the bicycle stem 33 in the axial direction of the steering column 3. Thus, since the torque transmission rotating body 22 and the steering assist motor 11 are located lower than the bicycle stem 33, the torque transmission rotating body 22 and the steering assist motor 11 can be arranged in a lower position relative to the steering column 3, and interruption of the torque transmission rotating body 22 and the steering assist motor 11 to a handle operation can be prevented.

In this example embodiment, the torque transmission rotating body 22 and the bicycle stem 33 are pressed to each other in the axial direction of the steering column 3 by the axial direction pressing mechanism 8. Thus, the torque transmission rotating body 22 and the bicycle stem 33 can be pressed to each other in the axial direction of the steering column 3. Therefore, the torque transmission rotating body 22 can be caused to integrally rotate with the steering column 3 by the bicycle stem 33.

Moreover, in a case of an ahead stem, the axial direction pressing mechanism 8 can be realized with a portion of the ahead stem. Therefore, the above-described configuration can be realized without adding a new part or the like.

In this example embodiment, the torque transmission rotating body 22 and the bicycle stem 33 are pressed downward in the axial direction of the steering column 8 by the axial direction pressing mechanism 8. Thus, the torque transmission rotating body 22 and the bicycle stem 33 can be pressed to the vehicle body frame or the like, and therefore, the torque transmission rotating body 22 can be caused to be sandwiched between the bicycle stem 33 and the vehicle body frame. Accordingly, the torque transmission rotating body 22 can be caused to integrally rotate with the steering column 3 by the bicycle stem 33.

In this example embodiment, the torque transmission rotating body 22 directly contacts the bicycle stem 33, and not via a rotation transmission member. Thus, even without a rotation transmission member, the torque transmission rotating body 22 can be caused to integrally rotate with the steering column 3 by the bicycle stem 33.

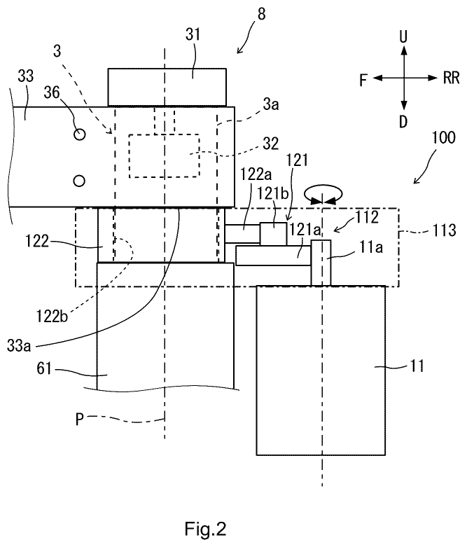

FIG. 2 is a left side view illustrating an outline configuration of a bicycle steering assist motor unit 100 according to a second example embodiment of the present invention. The bicycle steering assist motor unit 100 according to this example embodiment is different from the bicycle steering assist motor unit 1 of the first example embodiment in that a torque transmitter 121 of a torque transmission 112 is a gear including two-stage gear portions 121a and 121b, and a torque transmission rotating body 122 includes a gear portion 122a. In the following description, components similar to those of the first example embodiment are denoted by the same reference characters and will be omitted, and only components different from the first example embodiment will be described.

As illustrated in FIG. 2, the bicycle steering assist motor unit 100 includes a steering assist motor 11 and the torque transmission 112. The torque transmission 112 includes the torque transmitter 121 and the torque transmission rotating body 122.

The torque transmitter 121 is the gear including the two-stage gear portions 121a and 121b. Specifically, the torque transmitter 121 includes the first gear portion 121a and the second gear portion 121b having a smaller diameter than that of the first gear portion 121a. The first gear portion 121a overlaps the second gear portion 121b such that respective rotation axes thereof match each other. The first gear portion 121a and the second gear portion 121b are integral. Note that the torque transmitter 121 is housed in a casing 113.

The first gear portion 121a engages with a gear portion (not illustrated) provided on an outer peripheral surface of an output shaft 11a of the steering assist motor 11. The second gear portion 121b engages with the gear portion 122a of the torque transmission rotating body 122, which will be described below.

The torque transmission rotating body 122 includes the gear portion 122a on at least a portion of the outer peripheral surface. The gear portion 122a has, for example, a fan-like shape or a semicircular shape as viewed in the axial direction of a steering column 3. The gear portion 122 a engages with the second gear portion 121b of the torque transmitter 121. Similar to the torque transmission rotating body 22 of the first example embodiment, the torque transmission rotating body 122 includes an inner surface 122b the defines a gap between the torque transmission rotating body 122 and the steering column 3 in a state where the steering column 3 extends therethrough.

Similar to the torque transmission rotating body 22 of the first example embodiment, the torque transmission rotating body 122 is located between a bicycle stem 33 and a head tube 61 and is sandwiched with the bicycle stem 33 between a top cap 31 and the head tube 61. Thus, the torque transmission rotating body 122 integrally rotates with the steering column 3 via the bicycle stem 33.

With the above-described configuration, the output torque of the steering assist motor 11 can be transmitted to the steering column 3 by the torque transmission 112.

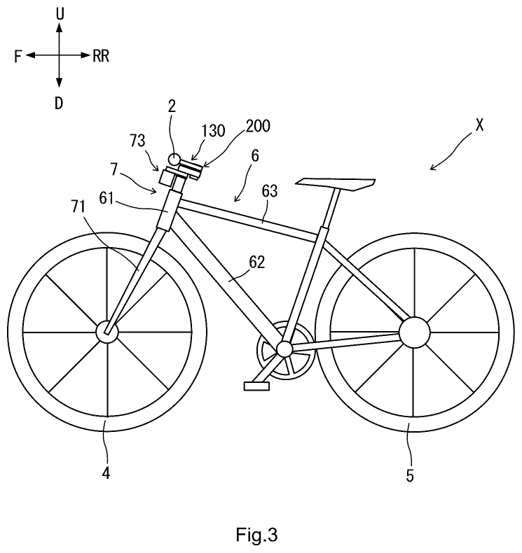

FIG. 3 is a left side view illustrating an outline configuration of a bicycle X including a bicycle steering assist motor unit 200 according to a third example embodiment of the present invention. The bicycle X according to this example embodiment is, for example, a two-wheeled vehicle. The bicycle X includes a front wheel 4, a rear wheel 5, a vehicle body frame 6, and a steering mechanism 7. Respective configurations of the front wheel 4, the rear wheel 5, and the vehicle body frame 6 are similar to those of known bicycles, and therefore, detailed description thereof will be omitted. Components similar to those of the first and second example embodiments are denoted by the same reference characters and description thereof will be omitted.

As illustrated in FIG. 3, the steering mechanism 7 includes a fork 71, a steering column 3, a stem mechanism 130, a steering assist device 73, and a handlebar 2. The steering column 3 obliquely extends such that an upper end thereof is located farther rearward than a lower end thereof.

The fork 71 rotatably supports the front wheel 4 at a lower end thereof. The steering column 3 is connected to an upper end of the fork 71. The steering column 3 extends through a head tube 61 of the vehicle body frame 6. The stem mechanism 130 is mounted on the upper end of the steering column 3. The handlebar 2 is supported by the stem mechanism 130. The steering assist device 73 assists steering of the handlebar 2 based on a torque input to the handlebar 2 or the steering column 3.

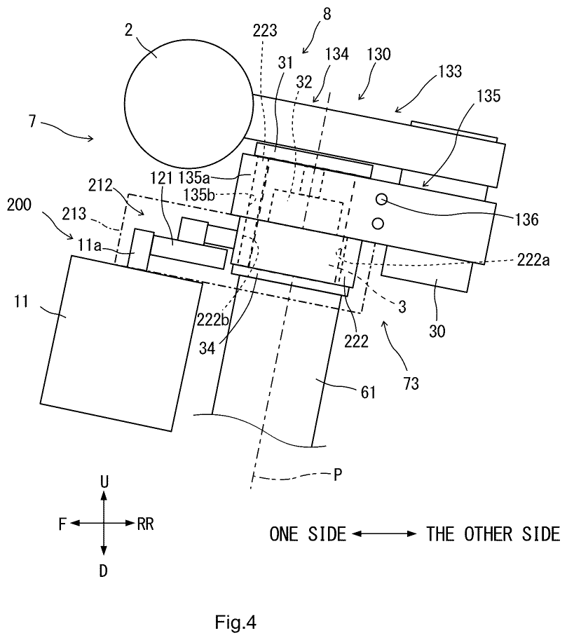

FIG. 4 is a view illustrating an outline configuration of the stem mechanism 130 and the steering assist device 73. The stem mechanism 130 includes a top cap 31, an anchor 32, and a bicycle stem 133.

The bicycle stem 133 includes a first stem 134, a torque sensor 30, and a second stem 135 (tightening member).

The first stem 134 includes an unillustrated handlebar connector at one end thereof. The handlebar 2 is connected to the handlebar connector. The other end of the first stem 134 is connected to the torque sensor 30.

The second stem 135 includes a steering column connector 135a that covers an outer peripheral surface of the steering column 3 at one end thereof. The steering column 3 is connected to the steering column connector 135a. The steering column connector 135a is attached to the outer peripheral surface of the steering column 3 in the tangential direction. For example, the steering column connector 135a has a cylindrical shape including a portion in a circumferential direction opened so as to sandwich the outer peripheral surface of the steering column 3 in a direction intersecting an axial direction (a lateral direction), and an opening portion thereof is attached to the outer peripheral surface of the steering column 3 in the tangential direction by a fastener 136 in a state where the steering column connector 135a sandwiches the steering column 3. A fastening position of the fastener 136 at the steering column connector 135a is located between the steering column 3 and the torque sensor 30 when the second stem 135 is viewed from a side.

The steering column connector 135a includes a stem recess 135b that accommodates a portion of a rotation transmission member 223 that will be described below in a location opposite to the fastener 136 with respect to the steering column 3 and on an inner surface of the steering column connector 135a. The stem recess 135b extends in the axial direction of the steering column 3. The other end of the second stem 135 is connected to the torque sensor 30.

The torque sensor 30 is located farther rearward than the steering column 3. Therefore, the second stem 135 is connected to the steering column 3 so as to extend rearward. The first stem 134 is located at an outer side of the steering column 3 in the axial direction and extends in a direction that intersects the axis P of the steering column 3 as viewed in the left-right direction.

The torque sensor 30 is located at a position where, as viewing the bicycle stem 133 in the front-rear direction, the torque sensor 30 overlaps at least a portion of the anchor 32.

Thus, the torque sensor 30 is located in an upper portion of the steering column 3 and where the torque sensor 30 overlaps at least a portion of the anchor 32, as viewing the bicycle stem 133 in the left-right direction or the front-rear direction. That is, the torque sensor 30 can be prevented from protruding largely upward relative to the upper portion of the steering column 3. Therefore, the torque sensor 30 can be compactly arranged relative to the steering column 3 in the up-down direction.

The steering assist device 73 includes the torque sensor 30 and the bicycle steering assist motor unit 200. The bicycle steering assist motor unit 200 includes the steering assist motor 11 and the torque transmission 212. The torque transmission 212 is housed in a casing 213 supported by the vehicle body frame.

The torque transmission 212 includes a torque transmitter 121, a torque transmission rotating body 222, and a rotation transmission member 223. Similar to the torque transmission rotating body 122 of the second example embodiment, the torque transmission rotating body 222 includes an inner surface 222a and a gap between the torque transmission rotating body 222 and the steering column 3 in a state where the steering column 3 extends therethrough such that the torque transmission rotating body 222 can be easily inserted and a torque of the steering assist motor 11 is not directly transmitted from the torque transmission rotating body 222 to the outer peripheral surface of the steering column 3.

The torque transmission rotating body 222 is sandwiched together with the steering column connector 135a between the top cap 31 of the stem mechanism 130 and a bearing portion 34 that rotatably supports the torque transmission rotating body 222 relative to the head tube 61 in the axial direction of the steering column 3. Note that a bearing or the like is provided between the steering column connector 135a and the casing 213. Thus, the steering column connector 135a is rotatable relative to the casing 213.

The torque transmission rotating body 222 is sandwiched together with the steering column connector 135a between the top cap 31 and the bearing portion 34 in the axial direction of the steering column 3, as described above, to transmit a torque transmitted from the torque transmitter 121 to the steering column 3 and the steering column connector 135 a. Therefore, the second stem 135 corresponds to the tightening member in the bicycle steering assist motor unit 200. That is, the bicycle steering assist motor unit 200 also includes the second stem 135 that rotates the torque transmission rotating body 222 integrally with the steering column 3.

The torque transmission rotating body 222 includes a transmission recess 222b (second recess, torque transmission recess) that houses a portion of the rotation transmission member 223 on the inner surface 222a. The transmission recess 222b extends in the axial direction of the steering column 3. That is, the transmission recess 222b is recessed in the axial direction of the steering column 3. The transmission recess 222b is provided on the torque transmission rotating body 222 so as to be connected to the stem recess 135b provided on the steering column connector 135a of the second stem 135. In this example embodiment, the transmission recess 222b is provided on the inner surface 222a of the torque transmission rotating body 222, specifically on an inner surface of a portion thereof where the torque transmitter 121 transmits the torque.

The rotation transmission member 223 is a rod-shaped member that connects the torque transmission rotating body 222 and the second stem 135 such that the torque transmission rotating body 222 and the second stem 135 can integrally rotate. The rotation transmission member 223 is a separate member from the torque transmission rotating body 222, the second stem 135, and the steering column 3. The rotation transmission member 223 extends in the axial direction of the steering column 3 between the inner surface of the torque transmission rotating body 222 and the inner surface of the second stem 135 and the outer peripheral surface of the steering column 3 and connects the torque transmission rotating body 222 and the second stem 135 such that the torque transmission rotating body 222 and the second stem 135 can integrally rotate. An upper portion of the rotation transmission member 223 is housed in the stem recess 135b provided at the inner surface of the steering column connector 135a of the second stem 135. A lower portion of the rotation transmission member 223 is housed in the transmission recess 222b provided at the inner surface 222a of the torque transmission rotating body 222. Therefore, the rotation transmission member 223 includes a projection that contacts an inner surface of the transmission recess 222b and also an inner surface of the stem recess 135b. That is, the rotation transmission member 223 includes a projection that fits with the transmission recess 222b that serves as a torque transmission recess in the torque transmission rotating body 222.

The projection corresponds to a first projection that protrudes from the torque transmission rotating body 222 in the axial direction and the stem recess 135b corresponds to a first recess. The stem recess 135b of the second stem 135 contacts the rotation transmission member 223 that integrally rotates with the torque transmission rotating body 222 to function as a torque transmitter that transmits the torque between the second stem 135 and the torque transmission rotating body 222.

According to the above-described configuration, the torque transmission rotating body 222 and the second stem 135 are caused to integrally rotate by the rotation transmission member 223. As described above, the second stem 135 integrally rotates with the steering column 3, and therefore, the torque transmission rotating body 222 integrally rotates with the steering column 3 via the second stem 135.

In this example embodiment, the bicycle steering assist motor unit 200 includes the rotation transmission member 223 that extends in the axial direction of the steering column 3 between the inner surface 222a of the torque transmission rotating body 222 and the inner surface of the second stem 135 and the outer peripheral surface of the steering column 3 and connects the torque transmission rotating body 222 and the second stem 135 such that the torque transmission rotating body 222 and the second stem 135 can integrally rotate.

Thus, the second stem 135 and the torque transmission rotating body 222 can be caused to integrally rotate by the rotation transmission member 223. Accordingly, the torque of the steering assist motor 11 input to the torque transmission rotating body 222 is transmitted to the steering column 3 via the rotation transmission member 223 and the second stem 135 that is attached to the steering column 3. Therefore, with the above-described configuration, the torque of the steering assist motor 11 can be more reliably transmitted to the steering column 3.

In this example embodiment, the rotation transmission member 223 is a separate member from the torque transmission rotating body 222, the second stem 135, and the steering column 3. Thus, a configuration in which the torque transmission rotating body 222, the second stem 135, and the steering column 3 integrally rotate can be easily realized and the torque transmission rotating body 222, the second stem 135, and the steering column 3 can be realized with a simple configuration without having complex shapes.

In this example embodiment, the second stem 135 includes the stem recess 135b as a torque transmitter that contacts the rotation transmission member 223 that integrally rotates with the torque transmission rotating body 222 and thus transmits the torque between the second stem 135 and the torque transmission rotating body 222. Specifically, the second stem 135 includes the stem recess 135b that extends in the axial direction and can house the rotation transmission member 223 on the inner surface thereof.

Thus, the rotation transmission member 223 can be provided on the inner surface of the second stem 135 without impairing a function of the second stem 135 as a stem. Moreover, since no machining of the steering column 3 is required to mount the rotation transmission member 223, the rotation transmission member 223 can be easily mounted on the steering column 3. Therefore, a configuration in which the second stem 135 can achieve both the function as a stem and a function as a member that transmits the torque of the steering assist motor 11 to the steering column 3 from the torque transmission rotating body 222 can be easily realized.

In this example embodiment, the stem recess 135b as a torque transmitter is the first recess in the second stem 135 to contact the first projection of the rotation transmission member 223 that protrudes from the torque transmission rotating body 222 in the axial direction of the steering column 3.

Thus, the torque transmitter that transmits the torque between the second stem 135 and the torque transmission rotating body 222 can be realized in the second stem 135. That is, the stem recess 135b of the second stem 135 contacts the first projection that protrudes from the torque transmission rotating body 222 in the axial direction of the steering column, and therefore, the torque transmission rotating body 222 can be caused to integrally rotate with the steering column 3 by the second stem 135.

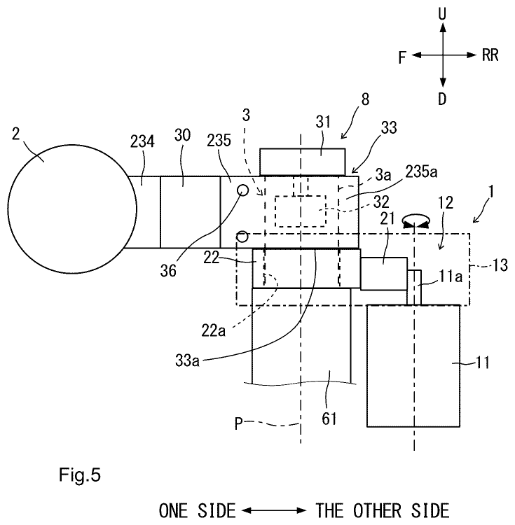

FIG. 5 is a view illustrating an example of a configuration of a bicycle stem 33 provided with a torque sensor 30 according to fourth example embodiment of the present invention. Specifically, as illustrated in FIG. 5, the bicycle stem 33 includes a handlebar holder 234, a steering column holder 235, and the torque sensor 30. The handlebar holder 234 includes a handlebar connector. Note that the handlebar holder 234 and the steering column holder 235 may be separate members. Except the following description, a configuration of this example embodiment is similar to that of the first example embodiment, and therefore, description of same portions as those of the first example embodiment is omitted.

Each of the handlebar holder 234 and the steering column holder 235 is connected to the torque sensor 30. The handlebar holder 234 is a rod-shaped member. The handlebar holder 234 includes a handlebar connector that is connected to the handlebar 2 at one end thereof. The other end of the handlebar holder 234 is connected to the torque sensor 30. The steering column holder 235 is a rod-shaped member. The steering column holder 235 includes a steering column connector 235a that is connected to the steering column 3 at the other end. The one end of the steering column holder 235 is connected to the torque sensor 30. Each of the handlebar connector and the steering column connector 235a has, for example, a clamp structure.

The steering column holder 235 is configured such that, as viewed in the axial direction of the steering column 3, the torque sensor 30 and the handlebar holder 234 are radially spaced apart from the steering column 3. Thus, the handlebar 2, that is connected to the handlebar connector of the handlebar holder 234, is also radially spaced apart from the steering column 3, as viewed in the axial direction of the steering column 3.

The handlebar holder 234, the torque sensor 30, and the steering column holder 235 are linearly arranged in the front-rear direction as viewing the bicycle stem 33 from above. That is, as viewing the bicycle stem 33 in the front-rear direction, the handlebar holder 234, the torque sensor 30, and the steering column holder 235 overlap. Thus, the torque sensor 30 can be compactly arranged in the left-right direction relative to the bicycle stem 33.

In the example illustrated in FIG. 5, the torque sensor 30 is located in the front-rear direction relative to the steering column connector 235a. However, the torque sensor may be also located in the left-right direction relative to the steering column connector. In this case, the torque sensor may be located where at least a portion thereof overlaps the steering column connector as viewing the bicycle stem in the left-right direction. The above-described arrangement of the torque sensor may be also applied to the configuration of the third example embodiment.

In the example illustrated in FIG. 5, the steering column holder 235, the torque sensor 30, and the handlebar holder 234 are arranged in an order of the steering column holder 235, the torque sensor 30, and the handlebar holder 234 from the steering column 3 toward the handlebar 2 as viewed from above. However, as long as the torque sensor is located between the steering column holder and the handlebar holder, the steering column holder, the torque sensor, and the handlebar holder may be arranged in any order.

In the example illustrated in FIG. 5, the torque sensor 30 is located farther forward than the steering column 3. However, the torque sensor may be located farther rearward than the steering column, and may be located to the left or right relative to the steering column.

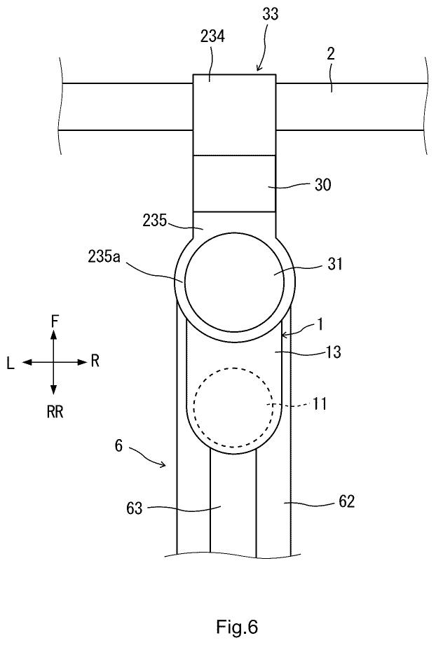

FIG. 6 is a view illustrating the bicycle stem 33 and the bicycle steering assist motor unit 1, as viewed from above. As illustrated in FIG. 6, at least a portion of the steering assist motor 11 of the bicycle steering assist motor unit 1 overlaps a down tube 62 of the vehicle body frame 6 of the bicycle, as viewed from above. In this example embodiment, a width of the down tube 62 is wider than the width of the top tube 63.

Thus, the bicycle steering assist motor unit 1 can be compactly provided on the bicycle. Note that the steering assist motor 11 is located farther upward than the down tube 62.

Example embodiments of the present invention have been described above, but the above-described example embodiments are merely illustrative examples for carrying out the present invention. Therefore, the present invention is not limited to the above-described example embodiments and the above-described example embodiments can be appropriately modified and implemented without departing from the gist of the present invention.

In each of the example embodiments described above, a case of an ahead stem structure has been described. However, the configuration of each of the above-described example embodiments is applicable also to a quill stem structure in which a portion (quill) of a stem is inserted in and fixed to a steering column. In this case, the stem includes a handlebar connector that is connected to a handlebar and a rod-shaped steering column connector inserted in the steering column and has a portion protruding farther upward than a vehicle body frame. A tightening member is tightened with respect to the outer peripheral surface of the stem in the tangential direction such that the torque transmission rotating body can integrally rotate with the steering column connector in a state where the steering column connection member extends through the torque transmission rotating body. The tightening member includes a torque transmitter that contacts a portion of the torque transmission rotating body to transmit a torque between the tightening member and the torque transmission rotating body. Thus, also in a quill stem structure, similar to each of the above-described example embodiments, an output torque of a steering assist motor can be transmitted to a steering column. In the above case, note that the steering column connector corresponds to the rotation axis.

As described above, when the configuration of each of the above-described example embodiments is applied to a quill stem structure, the tightening member is tightened to the steering column connector that is the rotation axis of the stem, and therefore, the tightening member can be tightened using a rigidity of the steering column connector. Therefore, the tightening member can be more firmly tightened to and mounted on the steering column, and the torque of the motor can be more reliably transmitted to the steering column.

Note that, also in the above-described quill stem structure, the rotation transmission member 223 of the third example embodiment may be provided between the torque transmission rotating body and the tightening member, and the steering column connector such that the torque transmission rotating body and the tightening member are caused to integrally rotate.

In each of the above-described example embodiments, each of the torque transmissions 12, 112, and 212 includes a corresponding one of the torque transmitters 21 and 121 and a corresponding one of the torque transmission rotating bodies 22, 122, and 222. However, the torque transmission may include only the torque transmission rotating body. In this case, the output torque of the steering assist motor is transmitted to the torque transmission rotating body.

In each of the above-described example embodiments, as the rotation transmission member, some other member (for example, a disc-shaped member, such as a washer, or the like) may be arranged between a corresponding one of the torque transmission rotating bodies 22, 122, and 222 and the bicycle stem 33 or the second stem 135 as the tightening member. Thus, the torque can be transmitted between each of the torque transmission rotating bodies 22, 122, and 222 and the bicycle stem 33 or the second stem 135 via the rotation transmission member and each of the torque transmission rotating bodies 22, 122, and 222 and the bicycle stem 33 or the second stem 135 can be caused to integrally rotate. In this case, the torque transmission rotating body, the rotation transmission member, and the tightening member may be pressed to each other in the axial direction of the rotation axis by the axial direction pressing mechanism of each of the example embodiments. Thus, a larger torque can be transmitted between each of the torque transmission rotating bodies 22, 122, and 222 and the bicycle stem 33 or the second stem 135.

Moreover, also in each of the above-described configurations, as in the third example embodiment, a rod-shaped rotation transmission member that connects a corresponding one of the torque transmission rotating bodies 22, 122, and 222 and the bicycle stem 33 or the second stem 135 such that each of the torque transmission rotating bodies 22, 122, and 222 and the bicycle stem 33 or the second stem 135 integrally rotate may be provided.

Note that, in the tightening member, the near side surface to the torque transmission rotating body that contacts the near side surface of the rotation transmission member to the tightening member is the torque transmitter. The torque transmission member includes a rotation transmission member torque transmitter that receives a load in the axial direction of the steering column to contact the side surface of the torque transmission rotating body. The rotation transmission member may include a recess that fits with a torque transmission projection in the torque transmission rotation body or a projection that fits with a torque transmission recess in the torque transmission rotating body.

In each of the above-described example embodiments, a corresponding one of the torque transmission rotating bodies 22, 122, and 222 is located farther upward than the bicycle stem 33 or the second stem 135 as the tightening member in the axial direction of the steering column 3. However, the torque transmission rotating body may be located lower than the tightening member in the axial direction of the steering column.

In each of the above-described example embodiments, a corresponding one of the torque transmission rotating bodies 22, 122, and 222 and the bicycle stem 33 or the second stem 135 as the tightening member are pressed in the axial direction of the steering column 3 by the pressing mechanism 8. However, the torque transmission rotating body and the tightening member may not be pressed in the axial direction of the steering column by the pressing mechanism.

In each of the above-described first, second, and fourth example embodiments, a corresponding one of the torque transmission rotating bodies 22 and 122 is sandwiched between the bicycle stem 33 and the head tube 61 and thus integrally rotates with the steering column 3 via the bicycle stem 33. However, as in the third example embodiment, the bicycle stem and the torque transmission rotating body may be connected by the rotation transmission member so as to integrally rotate.

In each of the first and second example embodiments, the steering column 3 extends in the up-down direction. However, similar to the third example embodiment, the steering column may extend in an oblique direction. The steering column of the third example embodiment may also extend in the up-down direction, similar to the first and second example embodiments.

In each of the first and second example embodiments, the steering assist motor 11 is located farther rearward than the steering column 3. In the third example embodiment, the steering assist motor 11 is located farther forward than the steering column 3. However, as long as the steering assist motor is located close to the steering column in front of, behind, at left, at right, or the like, the steering assist motor may be arranged in any position relative to the steering column.

In each of the first and second example embodiments, the torque transmission rotating body 122 is located closer to the head tube 61 than the bicycle stem 33. However, the torque transmission rotating body may be located farther from the head tube than the bicycle stem.

In each of the second and third example embodiments, the gear portion 122a of the torque transmission rotating body 122 has, for example, a fan-like shape or a semicircular shape as viewed in the axial direction of the steering column 3. However, the gear portion of the torque transmission rotating body may have a circular shape as viewed in the axial direction of the steering column.

In the third example embodiment, the bicycle steering assist motor unit 200 includes the torque transmission 212 having a similar configuration to that of the second example embodiment. However, the torque transmission of the bicycle steering assist motor unit may have a different configuration from that of the second example embodiment.

In the third example embodiment, the rotation transmission member 223 is a separate member from the torque transmission rotating body 222, the second stem 135, and the steering column 3. However, the rotation transmission member may be integral with any one of the torque transmission rotating body, the second stem, and the steering column. Moreover, a portion of the rotation transmission member may be integral with at least one of the torque transmission rotating body, the second stem, and the steering column.

For example, when the rotation transmission member is integral with the torque transmission rotating body, the torque transmission rotating body includes a first projection that protrudes from the torque transmission rotating body in the axial direction of the steering column. In this case, the torque transmitter of the second stem is a stem recess that contacts the first projection. Moreover, for example, when the rotation transmission member is integral with the second stem, the second stem includes a second projection that protrudes from the second stem in the axial direction of the steering column. In this case, the second projection is a torque transmitter that contacts the second recess that is recessed in the axial direction of the steering column in the torque transmission rotating body.

In the fourth example embodiment, at least a portion of the steering assist motor 11 of the bicycle steering assist motor unit 1 overlaps the down tube 62 of the vehicle body frame 6 of the bicycle, as viewed from above. However, the steering assist motor may not overlap the down tube of the vehicle body frame of the bicycle, as viewed from above.

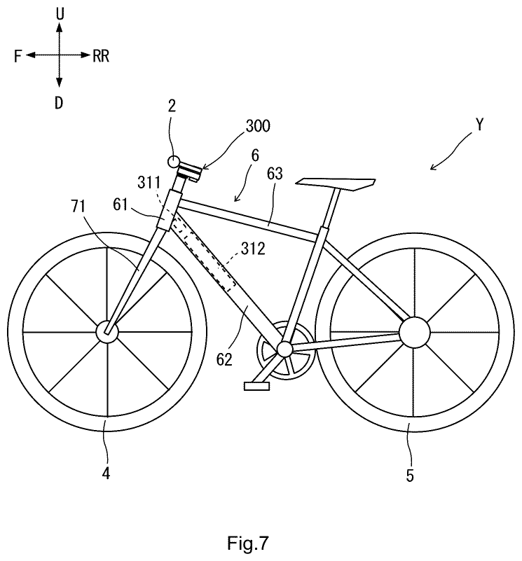

In the fourth example embodiment, the steering assist motor 11 is located farther upward than the down tube 62. However, the steering assist motor may be located lower than the down tube. Moreover, as illustrated in FIG. 7, the steering assist motor may be located inside the down tube.

FIG. 7 is a left side view illustrating an outline configuration of a bicycle Y configured such that a steering assist motor 311 and a battery 312 are housed in the down tube 62. The battery 312 supplies electric power to the steering assist motor 311. Although not particularly illustrated, a bicycle steering assist motor unit 300 includes a torque transmission that transmits an output torque of the steering assist motor 311 to the steering column 3.

Thus, a design quality of the bicycle Y on which the bicycle steering assist motor unit 300 is mounted can be increased. Furthermore, a center of gravity of the bicycle Y can be lowered by locating the steering assist motor 311 and the battery 312 in the down tube 62.

Note that the torque transmission may be housed in the down tube 62, and may be housed in the head tube 61. In an example illustrated in FIG. 7, the steering assist motor 311 is located closer to the head tube 61 than the battery 312. However, the steering assist motor may be located farther from the head tube than the battery and may be located at a same distance from the head tube as the battery. Moreover, one of the steering assist motor or the battery may be located outside the down tube and may be located in a top tube.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A bicycle steering assist motor unit comprising:
a torque transmission rotating body mountable on a steering column connected to a handlebar such that the steering column and the handlebar integrally rotate, the torque transmission rotating body being in a second torque transmission path through which a torque of a motor is transmitted via a first torque transmission path through which a torque input to the handlebar is transmitted to the steering column; wherein
the torque transmission rotating body protrudes upward from a vehicle body frame to rotate integrally with the handlebar and includes an inner surface through which a steering column extends via a gap such that the torque transmission rotating body is insertable relative to the steering column in the first torque transmission path and the torque of the motor is not directly transmitted to an outer peripheral surface of the steering column from the torque transmission rotating body;
the second torque transmission path includes a tightening member separate from the torque transmission rotating body such that the torque of the motor transmitted from the torque transmission rotating body is transmitted to the steering column, is aligned with the torque transmission rotating body in an axial direction of the steering column, and is attached to the outer peripheral surface of the steering column in a tangential direction to at least partially contact the outer peripheral surface of the steering column and integrally rotate with the steering column; and
the tightening member includes a torque transmitter that contacts a portion of the torque transmission rotating body or a rotation transmission member that integrally rotates with the torque transmission rotating body to transmit a torque between the torque transmitter and the torque transmission rotating body.

2. The bicycle steering assist motor unit according to claim 1, wherein the torque transmitter includes:
(1) a side surface of the tightening member that, upon receiving a load in the axial direction of the steering column, contacts a near side surface to the torque transmission rotating body or the tightening member in the rotation transmission member and is at or adjacent to the torque transmission rotating body;
(2) a first recess of the tightening member that contacts a first projection that protrudes in the axial direction of the steering column from the torque transmission rotating body or the rotation transmission member; or
(3) a second projection of the tightening member that contacts a second recess that is recessed in the axial direction of the steering column in the torque transmission rotating body or the rotation transmission member.

3. The bicycle steering assist motor unit according to claim 1, wherein the torque transmission rotating body is located lower than the tightening member in the axial direction of the steering column.

4. The bicycle steering assist motor unit according to claim 1, further comprising:
an axial direction pressing mechanism to press the torque transmission rotating body and the tightening member toward each other in the axial direction, or press the torque transmission rotating body, the rotation transmission member, and the tightening member toward each other in the axial direction.

5. The bicycle steering assist motor unit according to claim 4, wherein the torque transmission rotating body and the tightening member are pressed downward in the axial direction of the steering column by the axial direction pressing mechanism.

6. The bicycle steering assist motor unit according to claim 1, wherein the rotation transmission member is located between the torque transmission rotating body and the tightening member.

7. The bicycle steering assist motor unit according to claim 1, wherein the rotation transmission member includes:
a recess that fits with a torque transmission projection on the torque transmission rotating body, or includes a projection that fits with a torque transmission recess on the torque transmission rotating body; or
a rotation transmission member torque transmitter that contacts, upon receiving a load in the axial direction of the steering column, a side surface of the torque transmission rotating body.

8. The bicycle steering assist motor unit according to claim 1, wherein the torque transmission rotating body directly contacts the tightening member.

9. A bicycle comprising:
the bicycle steering assist motor unit according to claim 1.
